(19) United States
(12) Patent Application Publication
(10) Pub. No.: US 2015/0261195 A1
(43) Pub. Date: Sep. 17, 2015

(54) ARRIVAL TIME DISTRIBUTION CONTROL SYSTEM, ARRIVAL TIME DISTRIBUTION CONTROL DEVICE, AND INCENTIVE DESIGN METHOD

(71) Applicant: NEC CORPORATION, Minato-ku, Tokyo (JP)

(72) Inventor: Nobuharu Kami, Tokyo (JP)

(73) Assignee: NEC Corporation, Tokyo (JP)

(21) Appl. No.: 14/432,488

(22) PCT Filed: Oct. 1, 2013
(86) PCT No.: PCT/JP2013/076649

§ 371 Date: Mar. 31, 2015

(30) Foreign Application Priority Data
Oct. 1, 2012 (JP) 2012-219547

(51) Int. Cl. G05B 15/02

(52) U.S. Cl. CPC G05B 15/02

(57) ABSTRACT

An arrival time distribution control device, in an environment wherein users arrive at arbitrary times at a prescribed hub on the basis of compensation which is granted corresponding to each respective determination reference and arrival time, repeats, on the basis of the arrival times of the plurality of users who arrive at the prescribed hub, an arrival time distribution computation, and, for each the computation, on the basis of either a first difference between the current computed arrival time distribution and the previous computed arrival time distribution, or a third difference between the first difference and a second difference between the immediate previous computed arrival time distribution and the arrival time distribution computed prior to the previously computed arrival time distribution, causes fluctuations in the content of the compensation which is granted to the users who next arrive at the prescribed hub, reaching a target arrival time distribution.

### TECHNICAL FIELD

The present invention relates to an arrival time distribution control system, an arrival time distribution control device, and an incentive design method, by which a load amount of an entire system is controlled by incentive control.

### BACKGROUND ART

In a system in which a plurality of independent users behave according to respective action principles and which is used when the users behave, a situation, which is not desired by a manager such as the concentration of a load generated during system use, may frequently occur.

As an exemplary example of the case in which the load is concentrated as described above, there is a congestion rate of a train and the like. Passengers using a traffic system such as a railway decide boarding times according to their own independent judgment. However, typically, the number of passengers is not averagely distributed in each time zone, and users concentrate in a time zone such as a morning attending time and an evening return time called rush hours.

In order to improve such situations, a method, in which randomization is attempted in order to prevent an attending time and a quitting time from being concentrated by a change of a system such as flexible attendance, is also employed. Furthermore, there is a method for providing choice to an attending time by the flexible attendance as described above. On the other hand, there is also a method for granting predetermined compensation to users who performs off-peak attendance in order to prompt voluntary off-peak attendance by users.

Technologies for such a method for granting the compensation are disclosed in PTL 1 to PTL 3.

For example, PTL 1 discloses an automatic ticket gate system that aims at reducing the rate of congestion of trains. An object of the automatic ticket gate system is to reduce the rate of congestion by granting points in response to the rate of congestion at times at which a passenger enters/leaves a gate. In order to achieve the object, in the automatic ticket gate system, passengers are allowed to dynamically move in low hours of congestion to the maximum extent by using a repeatedly renewable function of an IC season ticket.

Furthermore, PTL 2 discloses a technology of allowing facilities in a station yard to be used in high hours of congestion in order to reduce the rate of congestion in rush hours, and granting points available in facilities in the station yard to users.

In the technologies disclosed in these Patent Literatures, the number of points to be granted is decided in response to the rate of congestion. Furthermore, in order to know boarding times of passengers and calculate the rate of congestion, an IC season ticket and a device introduced in a system such as IC season tickets and automatic ticket gates are used, and processing is completed in the system. In other words, since an application range of such a system is limited within the system, it may be called a closed system.

On the other hand, there have been used portable terminals, such as smart phones or cellular phones, having a function of acquiring their own current positions by using a positioning system represented as GPS (Global Positioning System). There are also applications using current positions and time information of users acquired by the position acquisition functions of such portable terminals. Note that, in the present specification, an “application” is not application software per se, but is assumed as an application having a function provided by cooperation of application software and hardware unless otherwise specifically mentioned.

An example of such an application is disclosed in PTL 3. In the technology disclosed in PTL 3, a position information application using smart phones and the like provides a service in which compensation is granted in response to the degree of movement of terminals. Since an object of the service is to allow a user to feel incentive for movement, it may be called a scheme of granting incentive in order to promote cooperation with a real space.

In addition to such a service, there has been considered a service and the like in which when a service provider cooperates with an existing shop and the like and a user directly enters the shop and performs position registration or purchases goods in the shop, the service provider grants virtual money used in the application or points capable of acquiring virtual items. Such a service also grants incentive to a user for the visiting to the shop and the purchase of goods in the shop by the user. An object of such a service is not to reduce the rate of congestion, but to increase the number of users visiting a shop and to prompt the purchase of specific goods.

### CITATION LIST

### Patent Literature

PTL1: Japanese Laid-open Patent Publication No. 2006-72699
PTL 2: Japanese Laid-open Patent Publication No. 2011-141773
PTL 3: Japanese Laid-open Patent Publication No. 2011-160934

### SUMMARY OF INVENTION

### Technical Problem

As described above, various technologies have been proposed as an incentive control technology. However, these technologies have the following problems.

General incentive control technologies as disclosed in PTL1, PTL2 and the like are mainly used in a closed system in which system use load information is designed by device use in a corresponding system as represented by the reduction of the rate of congestion of trains. In other words, the general incentive control technologies do not control a use load of a system serving as a separate object, in cooperation with an application using position information acquired by a portable terminal conforming to a standard such as GPS.

On the other hand, in incentive control introduced in a position information application using portable terminals of users disclosed in PTL 3 and the like, an incentive design scheme is qualitative. In this point, these technologies can induce a specific desirable action in which the sum of the number of visitors is increased through qualitative incentive design in which compensation is granted when visiting a shop. However, for various cases corresponding to requirements of allowing a user visiting at a predetermined time to visit in other time zones, an optimal quantitative incentive design guideline is not always apparent. Therefore, it is difficult to apply the technologies disclosed in PTL 3 and the like to the control of generally considered various cases as is.

Particularly, the technologies disclosed in PTL 3 and the like do not consider a difference of responses (whether to carry out a target action in response to a desired amount of compensation to be granted) of users for compensation. Therefore, it is not possible to optimize costs (the total amount of compensation to be granted) when incentive control is performed. Moreover, it is general that the response function is not known in many cases, and whether it is possible to realize a target state with an appropriate cost according to the amount of compensation to be set and a method thereof are not always apparent.

However, in order to efficiently perform use load control in a target system in cooperation with a position information application, it is necessary to provide a method for defining an optimal architecture and controlling a response action of a user using the application for compensation by using a quantitative design scheme.

An exemplary object of the present invention is to provide an arrival time distribution control system, an arrival time distribution control system, an arrival time distribution control device, and an incentive design method, by which it is possible to realize cooperation with an application using information of a current position and a time acquired or registered by a device and the like carried by a user, and to control a use distribution such as a time distribution of the number of arrivals and the number of service uses of a user to approach a desired distribution by an efficient amount of compensation to the maximum extent.

### Solution to Problem

According to an exemplary first aspect of the present invention, provided is an arrival time distribution control device in an environment in which a plurality of users arrive at a predetermined base at arbitrary times on the basis of compensation which is granted corresponding to respective judgment references and arrival times, wherein the arrival time distribution control device repeats calculation of an arrival time distribution based on the arrival times of the plurality of users having arrived at the predetermined base, and changes a content of the compensation which is granted to the users who arrive at the predetermined base next time so as to reach a target arrival time distribution, on the basis of either a first difference between a currently calculated arrival time distribution and an previously calculated arrival time distribution, or a third difference between the first difference and a second difference between the previously calculated arrival time distribution and an arrival time distribution calculated prior to the previously calculated arrival time distribution whenever the calculation is performed. The arrival time distribution in the present application means the number of users who arrive at arrival times at a certain point with respect to the arrival times of users.

According to an exemplary second aspect of the present invention, provided is an arrival time distribution control system including: a portable terminal having a positioning function; and the arrival time distribution control device provided according to the first aspect of the present invention, wherein the arrival time distribution control device includes a registration unit that registers the arrived base and arrival times when a plurality of users have arrived at the predetermined base, and the users carry the portable terminal, and the registration is performed for the registration unit on the basis of location information measured by the portable terminal.

According to an exemplary third aspect of the present invention, provided is an arrival time distribution control method which is performed by an arrival time distribution control device in an environment in which a plurality of users arrive at a predetermined base at arbitrary times on the basis of compensation which is granted corresponding to respective judgment references and arrival times, wherein calculation of an arrival time distribution, which is a time distribution of users having arrived at the predetermined base, is repeated, and whenever the calculation is performed, a content of the compensation, which is granted to the users who arrive at the predetermined base next time, is changed so as to reach a target arrival time distribution, on the basis of either a first difference between a currently calculated arrival time distribution and an previously calculated arrival time distribution, or a third difference between the first difference and a second difference between the previously calculated arrival time distribution and an arrival time distribution calculated prior to the previous calculated arrival time distribution.

### Advantageous Effects of Invention

According to an exemplary effect of the present invention, it is possible to realize cooperation with an application using information of a current position and a time acquired or registered by a device and the like carried by a user, and to control a use distribution such as a time distribution of the number of arrivals and the number of service uses of a user to approach a desired distribution by an efficient amount of compensation to the maximum extent.

### BRIEF DESCRIPTION OF DRAWINGS

FIG. 1 is a block diagram illustrating a basic configuration of an exemplary embodiment of the present invention.

FIG. 2 is a sequence diagram illustrating data transmission/reception and each process between a terminal and an administration server in an exemplary embodiment of the present invention.

FIG. 3 is a diagram illustrating one example of user classification in an exemplary embodiment of the present invention.

FIG. 4 is a diagram illustrating one example of transition of a user arrival time distribution in an exemplary embodiment of the present invention.

FIG. 5 is a diagram illustrating one example of a response function with respect to compensation of a user in an exemplary embodiment of the present invention.

FIG. 6 is a flowchart illustrating a basic operation in performing an incentive design method in an exemplary embodiment of the present invention.

FIG. 7 is a block diagram illustrating a basic configuration in a first implementation example of an exemplary embodiment of the present invention.

FIG. 8 is a diagram illustrating one example of user classification in a first implementation example of an exemplary embodiment of the present invention.

FIG. 9 is a block diagram illustrating a basic configuration in a second implementation example of an exemplary embodiment of the present invention.

### DESCRIPTION OF EMBODIMENTS

First, the outline of an exemplary embodiment of the present invention will be described. In the exemplary embodiment of the present invention, roughly, compensation of action times is granted to many independent agents (users) using a location information application using a portable terminal capable of acquiring location information, thereby inducing user's action and realizing the control of a load distribution of an entire system represented by an off-peak action.

In detail, in the present exemplary embodiment, a user can browse information related to compensation granted in response to an action. Then, on the basis of the information related to compensation, the user decides how to act, and registers location information by using a location information application system, thereby registering an action in a system administration server. On the other hand, the system administration server performs incentive design to approach a time distribution of the number of users input in advance with costs as low as possible, and grants compensation to the user in response to his/her action. Moreover, the user repeats a series of processes of preferably consuming the compensation within a constant period in an application in which the compensation is available. The above is the outline of the exemplary embodiment of the present invention.

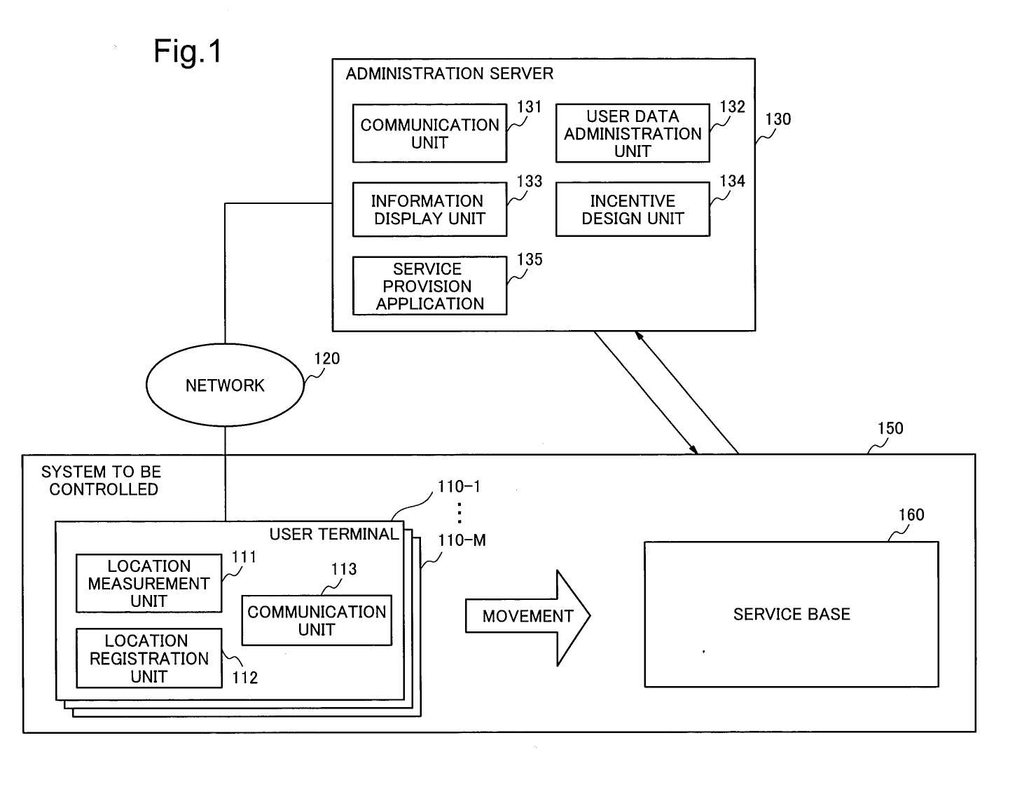

Subsequently, a description will be provided with reference to FIG. 1 representatively illustrating each functional block of the present exemplary embodiment.

Referring to FIG. 1, the exemplary embodiment of the present invention includes an administration server 130, a network 120, and a system 150 to be controlled.

Furthermore, the system 150 to be controlled includes a user terminal 110 carried by a user and a service spot 160.

A user carrying the user terminal 110 is a user to which compensation is granted in the present exemplary embodiment. The user moves to the service spot 160 at an arbitrary time on the basis of his/her judgment. Furthermore, the user receives compensation according to the movement and a service in which the compensation is available.

The user terminal 110 and the administration server 130 are communicably connected to each other via the network 120. The network 120, for example, can be implemented by the Internet; however, it is not always limited to the Internet. For example, the network 120 may be implemented by a mobile telephone network, or may be implemented by a combination of the Internet and the mobile telephone network. Furthermore, an LAN (Local Area Network) may also be included in the network 120. Moreover, there is no particular limitation in a communication scheme to which the network 120 should conform, and for example, the network 120 can conform to an arbitrary communication standard such as 3G (3^{rd} Generation), LTE (Long Term Evolution), WiMAX (Worldwide Interoperability for Microwave Access), and Wi-Fi (wireless fidelity).

Note that, in the present exemplary embodiment, it is assumed that there are a plurality of user terminals 110 carried by users. FIG. 1 illustrates a user terminal 110-1 to a user terminal 110-M (M is a positive integer equal to or more than 2). It is assumed that M at the end of each reference numeral denotes an arbitrary integer equal to or more than 2. Furthermore, in the following description, the end numeral of the user terminal 110 will be simply omitted to indicate any one of the user terminal 110-1 to the user terminal 110-M unless otherwise specifically mentioned.

Furthermore, in the present exemplary embodiment, only one service spot 160 is illustrated for the convenience of the illustration; however, a plurality of service spot 160 may exist.

The user terminal 110 includes a location measurement unit 111, a location registration unit 112, and a communication unit 113.

The location measurement unit 111 is a part that measures a current location of the user terminal 110 and acquires a measurement time of the current location. The measurement of the current location and the acquisition of the measurement time of the current location in the location measurement unit 111, for example, are realized by a positioning system using an artificial satellite represented as GPS (Global Positioning System) and the like. However, instead of such a positioning system, a positioning system such as AFLT (Advanced Forward Link Trilateration) using a positional relation with a base station may also be used, or a combination of these positioning systems may also be used.

The location registration unit 112 is a part that performs a process of registering the current location of the user terminal 110 and the measurement time of the current location measured by the location measurement unit 111 in the administration server 130. In detail, the location registration unit 112 transmits the current location of the user terminal 110 and the measurement time of the current location to the administration server 130 by using the communication unit 113. Then, the transmitted information is registered in the administration server 130. A registration process by the administration server 130 will be described later.

The communication unit 113 includes a function of transmitting/receiving information to/from the administration server 130 via the network 120. For example, the aforementioned transmission of the current location and the measurement time of the current location are realized by performing transmission using the network 120 by the communication unit 113.

Subsequently, details of the administration server 130 will be described. The administration server 130 is a server that administrates current location information of a plurality of users carrying respective user terminals 110. The administration of the current location information is performed on the basis of the current location information of the user terminals 110 carried by the users. In other words, the current locations of the user terminals 110 are regarded as the current locations of the users, thereby realizing the administration of the current location information of the users.

Furthermore, the administration server 130 has a function of granting compensation for actual actions of the users or administrating the amount of granted compensation, a history of granted compensation, and the like. In detail, the administration server 130 calculates incentive for prompting a user action based on the administrated current location information. Besides, the administration server 130 issues instructions to the user terminals 110, thereby presenting the calculated incentive information to users.

In detail, the administration server 130 includes a communication unit 131, a data administration unit 132, an incentive design unit 134, an information display unit 133, and a service provision application 135.

The communication unit 131 includes a function of transmitting/receiving information to/from the user terminals 110 via the network 120.

The user data administration unit 132 registers the location information of the user terminals 110 and arrival times, and administrates registered registration location information, granted incentive information and the like. The user data administration unit 132 constitutes a registration unit.

The information display unit 133 displays information related to incentive to the users. In detail, the information display unit 133 transmits the information related to incentive to be displayed to the users to the user terminals 110 by using the communication unit 131 via the network 120. Then, the transmitted information is displayed on the user terminals 110. The users can recognize the information related to incentive by referring to the information related to incentive displayed on the user terminals 110. The information display unit 133 constitutes a presentation unit.

The incentive design unit 134 calculates incentive for prompting the users to carry out a desired action.

The service provision application 135 provides the users with a predetermined service. The users can use acquired incentive in the service provided by the service provision application 135. Note that, the service provided by the service provision application 135 may have arbitrary content. A detailed example of the service provided by the service provision application 135 will be described later. The service provision application 135 constitutes an application implementation unit.

In the above, each functional block included in the present exemplary embodiment has been described. The user terminal 110 and the administration server 130 may be implemented by arbitrary devices. In detail, the user terminal 110 and the administration server 130 may be implemented by devices typical of the present exemplary embodiment. However, the user terminal 110 may be implemented by devices such as other general purpose smart phones, cellular phones, tablet type personal computers, note type personal computers, and portable game machines. Furthermore, the administration server 130 may be implemented by general purpose server devices. In any cases, programs typical of the present exemplary embodiment are installed in these devices, and these devices operate according to the programs typical of to the present exemplary embodiment, so that the user terminal 110 and the administration server 130 are implemented. Furthermore, the administration server 130 may be implemented by a single server device, and may also be implemented by cooperation of a plurality of devices. For example, the data administration unit 132 or the service provision application 135 may also be implemented by a storage device and the like connected to an exterior of a server device.

Next, cooperation of the user terminal 110 and the system 150 to be controlled included in the present exemplary embodiment will be described. The administration server 130 and the system 150 to be controlled of the present exemplary embodiment form a cooperative relation in advance. Furthermore, an arrival time distribution to the service spot 160 of users, which is preferable to the system 150 to be controlled, is notified to the administration server 130. On the other hand, the administration server 130 operates to allow the notified distribution to be preferable. In detail, the administration server 130 grants compensation for improving the convenience at the time of use of an application to users, thereby prompting the users to move to the service spot 160 at times which may contribute to realizing a target arrival time distribution. Furthermore, it is preferably assumed that the users steadily use the service provision application 135 provided by the administration server.

In more detail, in the present exemplary embodiment, incentive design is performed in order to control compensation to be granted when users have arrived at a certain point x serving as one example of the service spot 160 at times t. In this way, a distribution f(x,t) of the arrival times t of the users for the point x is made desirable.

In order to describe this point, going to office and going to school in attending office and attending school or the like are employed as a detailed example. Furthermore, a description will be provided for a method for prompting off-peak attendance in which attending times are not concentrated to the maximum extent.

However, an implementation method of the present exemplary embodiment is not limited to the method for prompting the off-peak attendance, and any methods may be employed if an object of the methods is to control the form of a distribution obtained by granting incentive to users in order to obtain a desired distribution. For example, the present exemplary embodiment may not only be applied to the method for prompting the off-peak attendance as described above, but can also be applied to an object of the reduction and the like of the rate of congestion in a shop selling articles, a restaurant, an amusement park and a business space such as a shopping center.

Furthermore, in the current description, for example, a plurality of users go to office serving as the service spot 160 in every morning attendance and the like, and control the user terminal 110 at that time, thereby registering an attending time and location information in the administration server 130. In the administration server 130, the user data administration unit 132 records and stores actual actions of users and recognizes the attending times of users. Furthermore, the administration server 130 decides the amount of compensation to be granted in response to an action of each user. In the current description, it is assumed that the amount of compensation to be granted is decided in response to the attending times of users. In detail, in order to obtain a desired arrival time distribution, the administration server calculates compensation to be granted to users with respect to the arrival times of the users by using the incentive design unit 134, and attempts to prompt a voluntary change in actions of the users. For example, when the attending time of a user 101 is concentrated just before business hours and attending times are allowed to be smooth to the maximum extent, incentive design for granting compensation is performed so as to prompt early morning attendance to the maximum extent. Users can refer to a result of the incentive design through the information display unit 133. In this way, the users can recognize the amount of compensation acquirable when moving to the service spot at a corresponding time, so that some or all of the users change his/her attending times. Then, the users register changed actual movement results in the administration server 130 through location information registration, and receives corresponding compensation. Furthermore, the users can use the acquired compensation by using the service provision application 135.

The service provision application 135 may be an application directly using location information or an application capable of beneficially using only compensation regardless of the location information.

Furthermore, compensation to be granted to users in order to grant incentive may have any type, and needs not to be an object which may be directly changed to cash such as money and coupons. For example, abstract compensation such as points available for a special purpose may also be employed.

In detail, a point as a right for drawing a lottery may be granted, rules in which users draw a lottery many times as the number of the points is large may be introduced, and actual money or right may be granted as a gift of the lottery. Moreover, virtual money, which causes profits when the points are used in an application operating on the user terminal 100 used by users, may also be employed. Particularly, virtual money or points available in game and the like using location information may also be used.

In other words, compensation is, for example, in a game, a right for acquiring virtual profits, such as purchase of virtual items used in game, or in a lottery application, a right for directly acquiring pecuniary profits such as a right for drawing a lottery many times.

The following description will be provided on the assumption that compensation is treated as “points” which are abstract values, and users are induced in order to obtain a desired distribution by granting points to a plurality of users as compensation.

In general, as a response to an action of a user for compensation, it is possible to assume qualitative properties in which it is easy to cause an action as the amount of the compensation is large, but a quantitative response amount thereof is not known in many cases. In other words, it is generally unknown that a user actually acts in proportional to the amount of granted compensation. In this regard, in the present exemplary embodiment, observation of an arrival time distribution after incentive design and re-performance of the incentive design in response to the observation result are repeated, so that the amount of compensation is decided and revised.

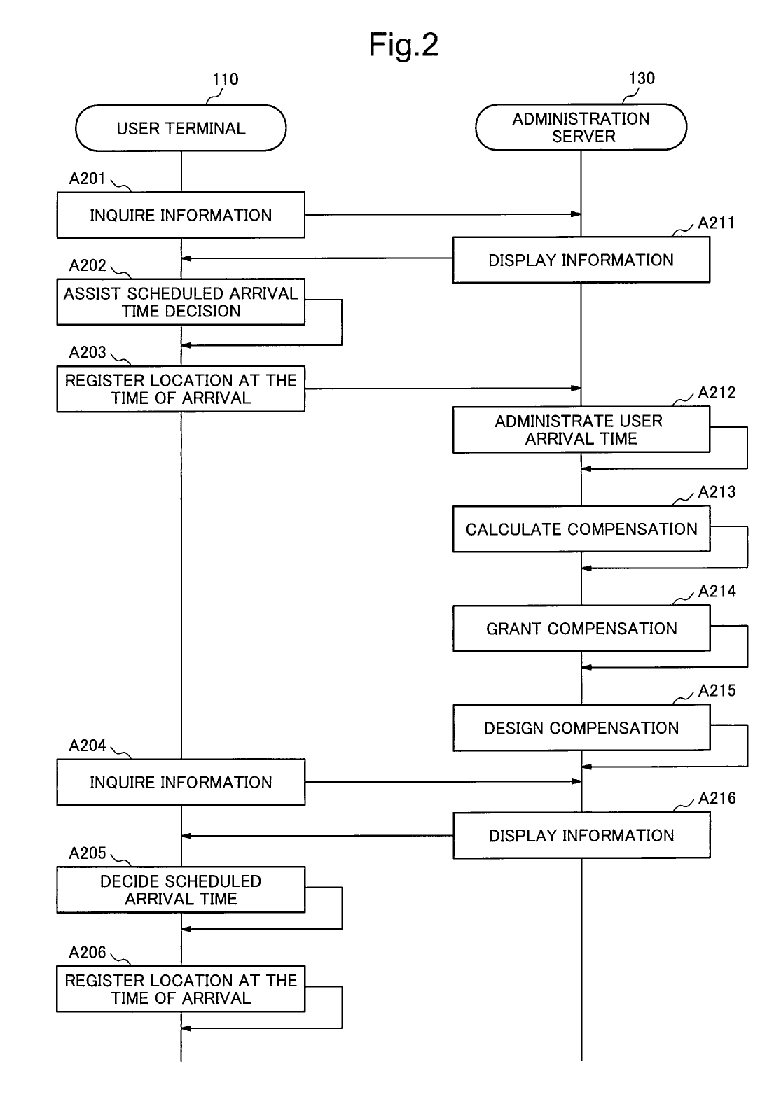

Next, with reference to FIG. 2, detailed operations of the user terminal 110 and the administration server 130 will be described in detail. FIG. 2 is a sequence diagram illustrating data transmission/reception and each process between the user terminal 110 and the administration server 130.

A user operates the user terminal 110 in order to recognize current incentive information related to a user. User terminal 110 accepts the operation, and transmits a reference request of incentive information to the administration server 130 (step A201).

Having accepted the reference request, the information display unit 133 of the administration server 130 transmits incentive information to be presented to the user to the user terminal 110 (step A211).

The user terminal 110 displays the received incentive information in order to assist the decision of the user for a scheduled attending time (step A202). The user refers to the incentive information, thereby recognizing the amount of compensation acquirable according to an office arrival time. Then, the user decides the scheduled attending time on the basis of the incentive information and goes to office in order to arrive at the scheduled attending time. When going to office, the user continuously carries the user terminal 110.

The process of information reference request and display is typically performed when the user accesses the administration server 130 by using a Web browser and the like via the network 120; however, the process may not be always performed in this way. For example, regardless of an operation of a user, the incentive information may also be automatically transmitted from the administration server 130 to the user terminal 110 at a predetermined cycle. Furthermore, the user terminal 110 may store the received incentive information and the stored incentive information may be displayed in response to an operation of a user.

When arriving at office, the user operates the user terminal 110. Having accepted the operation, the user terminal 110 uploads an arrival time and an arrival place to the administration server 130 (step A203). The administration server 130 registers the arrival time and the arrival place of the user 101 in the user data administration unit 132 as current location registration information in step A212.

At this time, the location measurement unit 111 of the user terminal 110 acquires location information by actually using GPS and the like. Moreover, the location registration unit 112 transmits a location measurement time together with the location information. Therefore, the administration server 130 side can confirm that the user 110 actually exists in the office (the measured location) at that time (the location measurement time).

Note that, the aforementioned description is based on the assumption that a device (for example, an application and the like on a smart phone) is used for registering a location acquisition result of GPS and the like by using the user terminal 110. However, the location registration at the time of arrival may also be realized using an attending time measurement administration system provided in an office. In other words, the attending time measurement administration system in the office and the administration server 130 may be allowed to cooperate with each other, and for example, the administration server 130 may perform the location registration at the time of arrival when the user holds up an IC card key in order to enter into the office. In this case, the user does not need to carry the user terminal 110 at the time of going to office. Therefore, in such a case, the user terminal 110 is not always to be a portable shape, and for example, it is also possible to realize the user terminal 110 by a stationary personal computer.

The incentive design unit 134 of the administration server 130 calculates the number of points of compensation to be granted to each user when user arrival information of all users is registered (step A213). Note that, when it is not possible to completely recognize the total number of users going to office at a corresponding date due to the possibility and the like of absence from work of users, the number of points of compensation to be granted to each user may also be calculated at a step at which arrival information of users exceeding the number of users decided in advance has been registered.

Then, the administration server 130 grants the compensation to the users on the basis of a result of the calculation in step A213 (step A214). The grant of the compensation is realized by updating user data administrated by the user data administration unit 132.

Next, the incentive design unit 134 of the administration server 130 calculates a current arrival time distribution. Then, the incentive design unit 134 compares the calculated current arrival time distribution with a desired arrival time distribution set in advance. Moreover, the incentive design unit 134 calculates next compensation by using a result of the comparison and available resource information, and decides incentive information to be displayed next time (step A215). The available resource information indicates information representing the total amount of funds of compensation to be granted to users when incentive design is performed. For example, as described herein, when the comparison is prepared in the form of points, the available resource information is granted in the form of the total point number, and the like.

Subsequently, in order to decide an attending time of the next day, the user operates the user terminal 110, similarly to step A201, so as to transmit a reference request of incentive information of the next date (step A204). Having accepted the reference request, the information display unit 133 of the administration server 130 transmits incentive information newly calculated in the calculation of step A215 to the user terminal 110 such that the incentive information newly calculated in the calculation of step A215 is displayed on the user terminal 110 (step A216).

The user terminal 110 displays the received incentive information newly calculated in the calculation of step A215 in order to assist the decision of the user for the attending time of the next date (step A205). Then, the user goes to office according to the attending time decided in step A205 the next day, and registers an arrival time at the time of arrival at the office in step A206. Step A206 corresponds to step A203, and then the similar processes are continued again from step A212.

Thereafter, the aforementioned identical processes are repeated every day, so that it is possible to allow office arrival distributions of users to gradually approach a desired arrival distribution.

The present exemplary embodiment as described above has an effect that by an application using information of a current position and a time acquired or registered by a device carried by a user, it is possible to control a time distribution of the number of arrivals and the number of service uses of a user to be a distribution desired by a system administrator by an efficient amount of compensation to the maximum extent.

Note that, in the aforementioned description, the present exemplary embodiment has been simply described in order to facilitate the understanding of the content. In other words, in the aforementioned description, the assignment of the compensation to be granted to each user by the incentive design is changed, but the desired distribution is fixed and a no limitation is set in the available resource information.

However, this is merely one example, and various conditions may be arbitrarily changed during the operation. In detail, in the compensation setting in step S215, the desired distribution or the available resource information may be changed.

For example, when it is not possible to reach the desired target distribution by the assignment of the compensation or the desired target distribution should be changed due to a change of a situation, the desired target distribution may be changed. In detail, when a response of a user is sensitive to a change in the compensation, the desired target distribution may be changed and smoothing more than considered may be attempted.

Moreover, in response to a present distribution, a change of an operation policy and the like, the available resources may also be increased or decreased. Typically, when it is determined that it is not possible to reach the desired target distribution even though the compensation is assigned using all methods in the current total amount of compensation, the increment of the compensation is performed. On the other hand, when it is possible to reach the desired target distribution without assigning all of the current total amounts of compensation, the decrement of the compensation is performed.

[Incentive Design]

Next, the incentive design method, which is performed by the incentive design unit 134 of the present exemplary embodiment in step A215 in FIG. 2, will be described in more detail.

In the current description, firstly, a plurality of users is classified in two standpoints of an “arrival time” and a “time required for attending office”. The arrival time indicates a time at which a user has arrived at a target service spot 160 (for example, an office). The time required for attending office indicates the length of a time required when a user carrying the user terminal 110 moves from a departure point (for example, the user's house) to the target service spot 160.

<Arrival Time Classification>

Initially, the arrival time is classified into time slots at an appropriate interval. For example, when an attending time is set to 9:00 AM, 7:00 to 9:00 are generally assumed as an estimated arrival time. The estimated time is classified into two time zones of “A1: 7:01 to 8:00” and “A2: 8:01 to 9:00” at an interval of 60 minutes. In such current classification, A1 means early attendance and A2 means late attendance.

Note that, in actual operation, there may be users going to office after 9:00 or before 7:00, but the presence of these users are ignored below in order to simplify the incentive design.

Furthermore, there is no special limitation in the scheme of the time zone classification and classification based on an arbitrary reference is possible. For example, in the present description, the estimated time is classified into two time slots of A1 and A2 for simplification. However, in general, it is sufficient if the estimated time is classified into an arbitrary number of time slots of two or more, and the arbitrary number of time slots can be set by a designer in response to environments of implementation. Moreover, for example, both a start time and an end time of a time slot are decided in the form of 7:01 to 8:00 herein. However, for example, there may exist a time slot specified only by any one of a start time and an end time in the form of before 7:00.

<Classification in Time Required for Attending Office>

Since users act on the basis of their own values or situations, responses of the respective users are generally different from one another. For example, even though the same amount of compensation is granted, an actual change in an action differs in each user.

For example, depending on various private circumstances, there are persons who do not early go to office even though compensation is very high and persons who early go to office by a simple motive. In this regard, users are grouped into a plurality of user groups on the assumption that responses (herein, the degree of a change in an attending time) for the amount of compensation are comparatively similar. This, for example, may be initially treated to be uniform, and then may be grouped through observation of the responses for the amount of presented compensation or may be grouped by certain prior knowledge.

As an example of a grouping reference, a required time for attending office (hereinafter, appropriately referred to as a “time required for attending office”) is used. A reason for using the time required for attending office is based on the assumption that attending times of all persons strongly depend on a departure time from his/her own house. In other words, since a person having a long time required for attending office should early depart from his/her own house, it is considered that the person having a long time required for attending office does not easily respond to compensation as compared with a person having a short time required for attending office.

The classification scheme in the time required for attending office is a parameter which may be arbitrarily set by an administrator, similarly to the classification scheme of the time slot. The time required for attending office is classified into G1: 0 to 30 minutes and G2: 31 to 60 minutes every 30 minutes, and the case of requiring 60 minutes or more is ignored herein. In this classification, G1 means users near an office and G2 means users remote from the office. Furthermore, it is assumed that responses of users belonging to the same group for compensation are almost the same. Similarly to the classification scheme based on the time slot, it is sufficient if users are generally classified into an arbitrary number of groups of two or more.

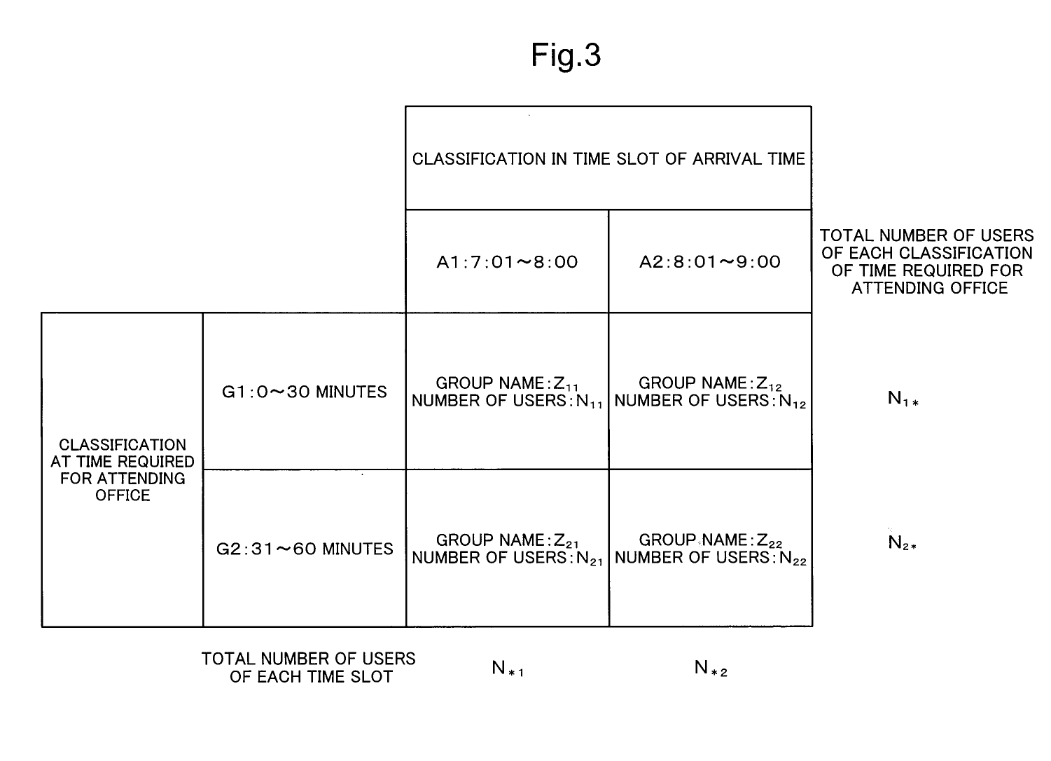

The classification based on two standpoints of the aforementioned arrival time classification and the classification in the time required for attending office may be represented by a 2×2 matrix of FIG. 3.

In the matrix of FIG. 3, a user group belonging to the classification Gi in the time required for attending office and the arrival time classification Aj are expressed by Zᵢⱼ (herein, i and j are arbitrary positive integers of two or more).

In this way, in the classification of 2×2, the user group is classified in four of {Zᵢ₁: a near user early goes to office}, {Z₁₂: a near user goes to office late}, {Z₂₁: a remote user early goes to office}, and {Z₂₂: a remote user goes to office late}. Furthermore, it is assumed that the total number of users belonging to Zᵢⱼ on the basis of attending times and times required for attending office of users is expressed by Nᵢⱼ. For example, among the users belonging to G2, a user 1 who has gone to office at the time slot of A1 belongs to Z₂₁ and the total number of users belonging to Z₂₁ is expressed by N₂₁.

Moreover, N_{i*}=Nᵢ₁+Nᵢ₂ denotes the total number of users belonging to a group Gᵢ and N_{*j}=N₁ⱼ+N₂ⱼ denotes the total number of users who has gone to office at a time slot Aj.

In this way, in the incentive design in the present exemplary embodiment, by granting as minimum compensation as possible, the distribution f(N_{*j}) of N_{*j} is allowed to approach a target distribution φ(N_{*j}) to the maximum extent.

In the example of attending office and the like, when a time slot number j is large (that is, a late time), the number of users is large. Therefore, it is general to allow j to be small and to make the number of users shift to an early time zone. Note that, it is more general to prompt transition from a time slot in which the number of users is large to a time slot in which the number of users is small. In the description of the present exemplary embodiment, it is discussed that the number of users is large in a time slot of a late time zone and the number of users is always small in a time slot of an early time zone. The following discussion can also be applied to the case in which the time slot of the early time zone is read as the time slot in which the number of users is small and the time slot of the late time zone is read as the time slot in which the number of users is large. For example, in examples other than attending office, since the number of users is large in the early time zone, it can also be applied to the case of shifting the number of users to the late time zone.

Furthermore, in the present exemplary embodiment, in order to realize off-peak attendance, each N_{*j} is smoothed to the maximum extent. Therefore, in the current description, in detail, N_{*2} is decreased to increase N_{*j}. As described above, the current description is based on the assumption that the number of users is large in the late time zone.

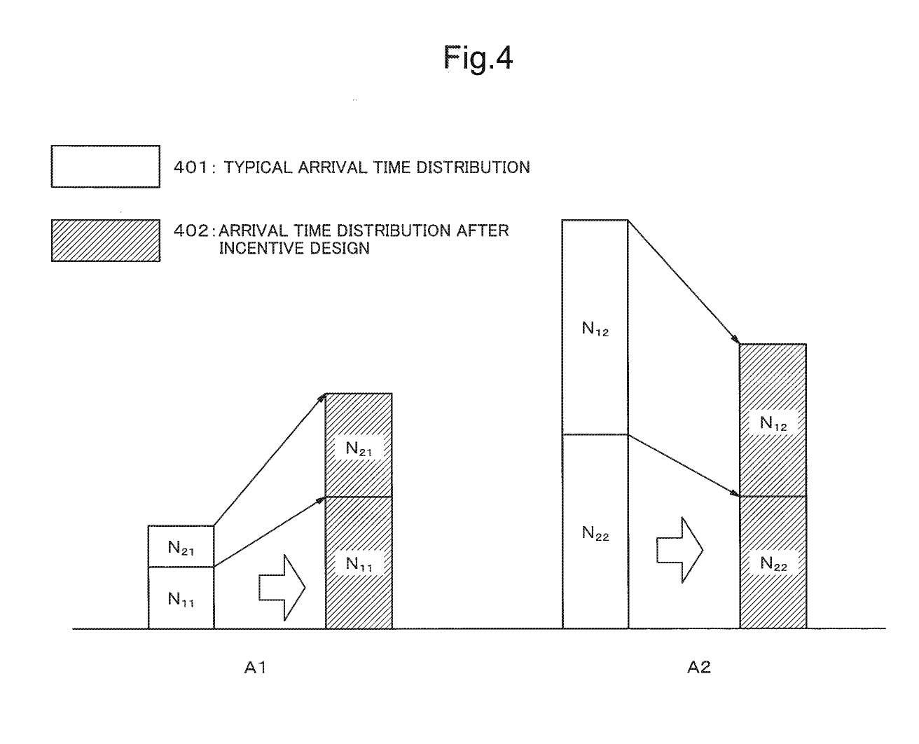

This point is illustrated in FIG. 4. Referring to FIG. 4, a typical exemplary arrival time distribution before the incentive design is illustrated as a typical arrival time distribution 401. As illustrated in the typical arrival time distribution 401, it is assumed that many users are distributed to belong to A2 which is a late time slot herein.

Furthermore, in the present exemplary embodiment, efficient incentive design is performed such that users belonging to the time slot of the late time are shifted to the time slot of the early time and thus an arrival distribution is changed to an arrival distribution 402 after incentive design.

A description for a detailed incentive design method will be continued. As compensation, points W are granted when going to office in the time slot A1. In this case, probability that a user belonging to the group Gᵢ (i=1,2) selects the time slot A1 is set as Pᵢ₁(W).

Note that, in general, Pᵢ₁ also depends on time. In other words, in the example of attending office, it is generally considered that when an arrival time is earlier morning, Pᵢ₁ is reduced to a certain degree. However, for the simplification of a description, it is assumed that Pᵢ₁ does not depend on time herein.

On the other hand, as described above, in the current description, since time slots other than A1 and A2 are not considered, a user selects any one of A1 and A2. Thus, probability that a user selects the time slot A2 is Pᵢ₂(W) (=1−Pᵢ₁(W)).

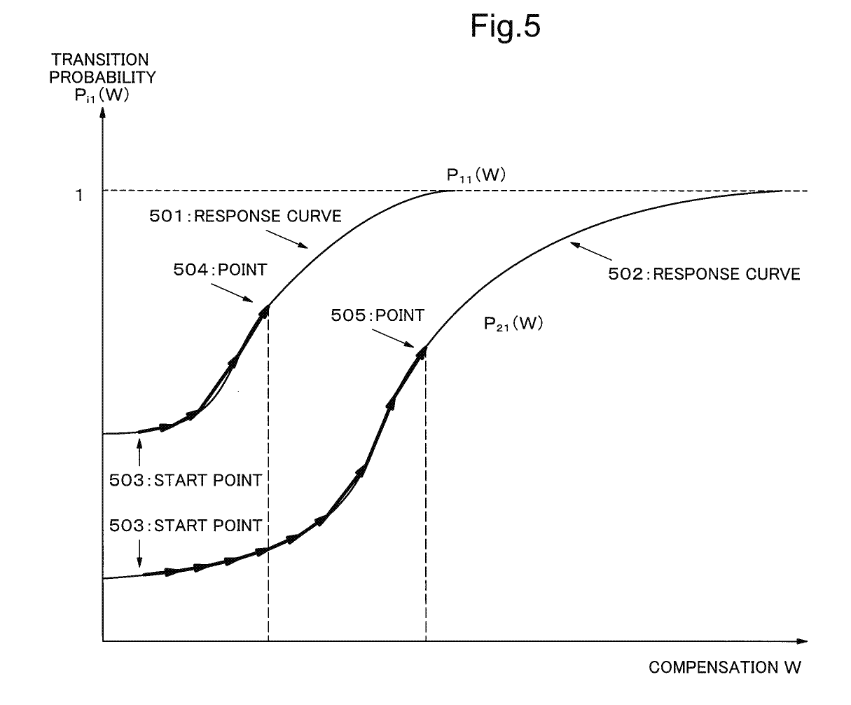

In this way, Pᵢ₁(W) is a monotonically increasing function and typically has a shape as illustrated in FIG. 5. In this way, an expected value of Nᵢⱼ is N_{i*}×Pᵢⱼ(W) and an expected value of the number N_{*j} of users of the time slot Aj (j=1,2) is E[N_{*j}](W)=N₁*×P₁ⱼ(W)+N₂*×P₂ⱼ(W). Note that, the aforementioned typical arrival time distribution 401 of FIG. 4 is a distribution when points are made zero, that is, when W=0.

When the form of Pᵢ₁(W) is already known, it is sufficient if optimal grant points are designed such that the arrival time distribution of users is allowed to approach the target arrival distribution by the total number of points to be granted to minimum users.

Particularly, when equally granting compensation to both groups, when W* is increased until E[N_{*i}](W*)=N₁*×P₁₁(W*)+N_{2*}×P₂₁(W*)=(N_{1*}+N_{2*})/2, the arrival distribution is completely smoothed, and the total number of points to be granted at this time is W*×(N_{1*}+N_{2*})/2. When there is a limit value Wmax in W, it is sufficient if the points are granted to min{Wmax,W*}.

On the other hand, when granting different amounts of compensation to both groups(referred to as W₁ and W₂), an expected value of the number of users arriving at the time slot A1 is E[N_{*1}](W₁,W₂)=N₁*×P₁₁(W₁)+N_{2*}×P₂₁(W₂) and the total point number is W₁×N₁*×P₁₁(W₁)+W₂×N_{2*}×P₂₁(W₂). Accordingly, under the restriction of the total point number W₁×N₁*×P₁₁(W₁)+W₂×N₂*×P₂₁(W₂)≦Wmax and the expected value E[N_{*1}](W₁,W₂)=N₁*×P₁₁(W₁)+N₂*×P₂₁(W₂)≦(N_{1*}+N_{2*})/2 of the total number of users arriving at the time slot A1, optimal (W₁,W₂) is sufficient when the expected value E[N_{*1}](W₁,W₂) of the number of users arriving at the time slot A1 is maximized.

As described above, when the form of Pᵢ₁(W) is already known, appropriate incentive design can be performed in advance. However, it is rare that the case in which the form of Pᵢ₁(W) is already known. Therefore, the case is small in which it is possible to analytically calculate an optimal compensation amount in advance. In this regard, the present exemplary embodiment uses a method for sequentially increasing compensation and finally approaching a target user arrival distribution under the restriction of the total point number.

In the case of granting equal compensation to both having arrived at the time slot A1 (users belonging to the user group G1 and users belonging to the user group G2), compensation for both is simply increased little by little. Hereinafter, the following description will be provided for the case of granting different amounts of compensation to both other than the case of granting equal compensation to both. This, for example, corresponds to design regarding whether it is possible to most efficiently shift a user arrival distribution if more compensation is granted to users who have gone to office at a certain time slot of a certain user group, on the basis of an arrival time distribution obtained for current compensation setting.

In a subsequent description, a certain amount X of a certain time k is expressed by X[k]. In the case of performing incentive design every day, k denotes a certain date and X denotes the number of users.

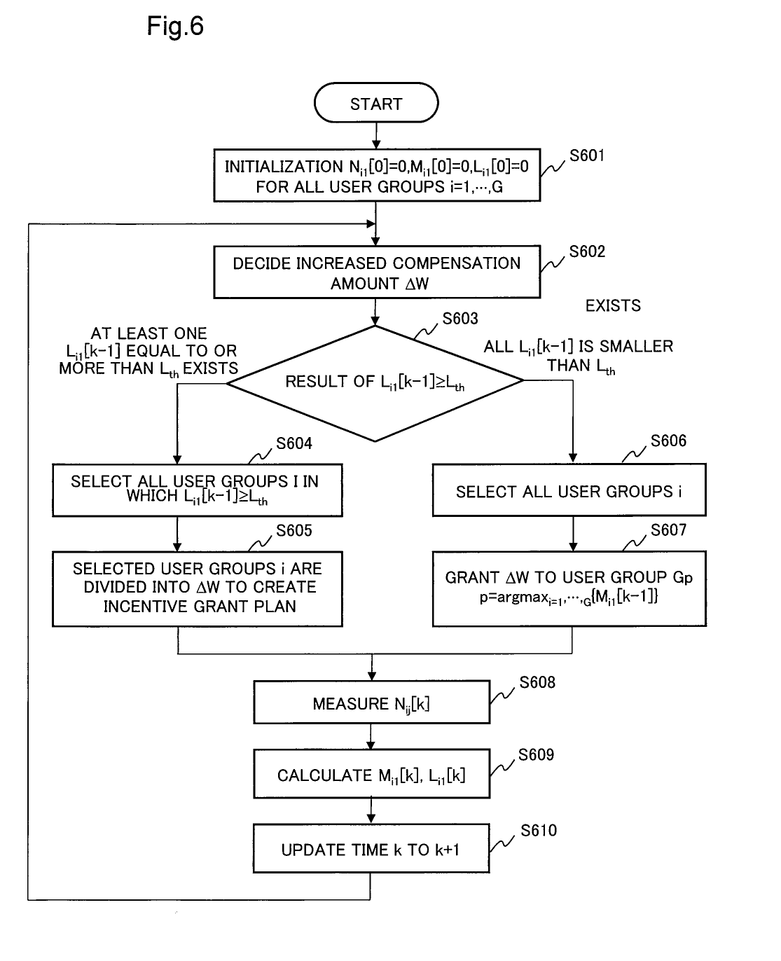

Next, with reference to the flowchart of FIG. 6, a basic operation when performing incentive design will be described.

Step S601: First, initialization is performed. In detail, k=1 and Nᵢ₁[0]=0,Mᵢ₁[0]=0,Lᵢ₁[0]=0 with respect to all user groups Gi(i=1, . . . , G=2 herein).

Nᵢ₁ denotes the total number of users belonging to the user group Gi. For example, the total number of users belonging to the user group Gi at the certain time k is Nᵢ₁ [k].

Moreover, Mi1 denotes the increased number of users from a certain time (for example, k−1) immediately preceding to a current certain time (for example, k) in the user group Gi. For example, Mᵢ₁[k]=Nᵢ₁[k]−Nᵢ₁ [k−1].

Moreover, Lᵢ₁ denotes a value obtained by subtracting the increased number of users calculated at the time point of an immediately preceding certain time (for example, k−1) from the increased number of users calculated at a current certain time (for example, k). For example, Lᵢ₁ [k]=Mᵢ₁ [k]−Mᵢ₁ [k−1].

Step S602: A compensation increase amount ΔW is decided. The compensation increase amount ΔW can be arbitrarily set within the range of the total number of points which can be granted.

Step S603: The size of Lᵢ₁[k−1] is compared with Lₜₕ, which is a threshold value set in advance, with respect to all the user groups Gi (Lᵢ₁[k−1]≧Lₜₕ). When there is at least one Lᵢ₁[k−1] equal to or more than Lₜₕ, the procedure proceeds to step S604. On the other hand, when all of Lᵢ₁[k−1] is smaller than Lₜₕ, the procedure proceeds to step S606. Note that, in a first step S603 after the initialization is performed in step S601, Lᵢ₁[k−1] is treated as 0.

Step S604: All the user groups Gi, in which Lᵢ₁[k−1]Lₜₕ, are selected. An aggregation G[k] of the selected user groups Gi is set as {Gi|Lᵢ₁[k−1]≧Lₜₕ}.

Step S605: The selected user groups Gi are equally divided by ΔW, so that an incentive grant plan is generated. In detail, a compensation amount for all user groups Gi belonging to next G[k] is increased by ΔW/#|G[k]|. #|G[k]| denotes the number of user groups belonging to G[k].

Step S606: All the user groups Gi are selected.

Step S607: With respect to all the user groups Gi, Mᵢ₁[k−1] is evaluated. Only compensation of a user group Gp with the largest Mᵢ₁[k−1] is increased by ΔW, so that an incentive grant plan is generated. It is assumed that p=argmax_{i=1, . . . , G}{Mᵢ₁[k−1]}.

Step S608: A new compensation amount based on the incentive grant plan generated in the aforementioned steps S601 to S607 is presented to users, and the number Nᵢⱼ[k] of users in a user group Zᵢⱼ of a result of the presentation is measured.

Step S609: Mᵢ₁[k](=Nᵢ₁[k]−Nᵢ₁[k−1]) and Lᵢ₁[k](=Mᵢ₁[k−1]) are calculated.

Step S610: A time k is updated to k+1 and the procedure proceeds to step S602.

By repeating the aforementioned processes, it is possible to sequentially increase compensation and finally approach a target user arrival distribution under the restriction of the total point number.

Gradual approach of a user arrival time distribution (an actually measured arrival time distribution) to a desired arrival time distribution, represents that a difference between the actually measured arrival time distribution and the desired arrival time distribution becomes equal to or less than a predetermined value.

The difference is a difference of the total number of users when the total number of users calculated in each time slot of the actually measured arrival time distribution and the total number of users calculated in each time slot of the desired arrival time distribution have been compared with in each equal time slot.

Furthermore, the fact that the difference becomes equal to or less than the predetermined value represents that the difference of the total number of users becomes equal to or less than the predetermined value. Note that, the predetermined value may be zero.

According to a description based on the example illustrated in FIG. 3, for example, when the difference between a value of N_{*2} in the actually measured arrival time distribution and a value of N_{*2} in the desired arrival time distribution becomes zero, it is possible to determine that the actually measured arrival time distribution has approached and has become the desired arrival time distribution. Note that, the value of N_{*2} in the actually measured arrival time distribution may be permitted to be larger than the value of N_{*2} in the desired arrival time distribution. However, if the value of N_{*2} in the actually measured arrival time distribution becomes considerably large, it is probable that inconvenience occurs. Therefore, it is preferable to be set within an appropriate range that is permitted.

Next, with reference to FIG. 5, a description will be provided for an example of a change in the number of users when the compensation increase plan based on the aforementioned incentive design scheme is applied. In the current example, Lₜₕ=0. A response curve 501 is a curve indicating probability P₁₁(W) that a user of the user group G1 goes to office at a time slot 1 when compensation is W. Moreover, a response curve 502 is a curve indicating probability P₂₁(W) that a user of the user group G2 goes to office at the time slot 1 when the compensation is W.

First, when starting from a start point 503 as a start point, since Lᵢ₁[k−1] of both user groups is equal to or more than Lₜₕ in the aforementioned step S603, the procedure proceeds to step S604 and both user groups are equally increased by ΔW. When this is repeated for some terms and a point 504 is reached with respect to the user group G1, Lᵢ₁[k−1] is smaller than Lₜₕ for the first time. Therefore, the procedure proceeds to step S606, and the compensation is increased only for the user group G2 by ΔW.

Thereafter, a compensation amount is increased only for the user group G2 until a point 505 is reached, and then Mᵢ₁[k] of both is compared with each other, and a large one is increased.

The aforementioned incentive design scheme is focused on the fact that a change in the number of users is a monotonically increasing function with respect to an increase in compensation, and the number of users is not uniformly increased, shows a gradually increased response, is most sensitively increased at a certain point, and then shows a reduced increase rate. In other words, in the example indicated by the response curve 502, it shows a gradually increased response from the start point 503, an immediately preceding response of a response at the point 505 is most sensitively increased, and an increase rate after the response at the point 505 is reduced. It can be considered that this reflects the fact that a response is small if a compensation amount is small, and there are users who respond for a very high compensation amount only by a constant degree. In other words, Nᵢ₁(W) is a monotonically increasing function (that is, Mᵢⱼ[k]≧0) and the slope of the monotonically increasing function has a single peak shape of gradually increasing with respect to an increase in compensation and starting to decrease after passing through a peak. When the compensation increase amount ΔW is small, the increased amount of the number of users can approximate to Mᵢⱼ[k]×ΔW, and there is an effect of an increase in the number of users based on the compensation-up from Mᵢⱼ[k]≧0. However, the effect of the increase passes through a peak at a certain point and then is reduced.

If the increased amount Mᵢⱼ[k]×ΔW of the number of users is assumed to be accurately measurable for the increase amount ΔW and the increased amount Mᵢⱼ[k]×ΔW has the same qualitative relation after the increase of ΔW, it is most efficient to invest the increase amount ΔW to a user group with a large M₁₁[k]×ΔW and M₂₁[k]×ΔW, and an optimal compensation plan at the time k+1 is (W[k]+ΔW, W[k]) or (W[k],W[k]+ΔW).

However, actually, it is difficult to accurately compare an estimated value of the next step by using data up to now, and it is also probable that an increase in the number of users with respect to the sudden increase amount is reduced. Therefore, in the aforementioned incentive design scheme, since it is considered that an investment effect is high for all groups until a transition of an increase rate in the number of users reaches a peak, compensation is increased, and when an increase rate of the number of users for all user groups has exceeded the peak, the increase amount Mᵢⱼ[k]×ΔW of the number of users is employed as a judgment index.

Note that, the aforementioned incentive design scheme is merely a specific example, and the following various modifications can be made without departing from the scope of the present invention.

For example, in the aforementioned description, an effect of a statistical variation is not considered in each measurement. In order to reduce the statistical variation, a compensation revision cycle is not daily updated, and revising compensation once in an appropriate period is effective. At this time, the measurement of Nᵢⱼ[k] or the update of Mᵢⱼ[k], Lᵢⱼ[k] can be combined with a statistical estimation method by using a plurality of pieces of measurement data measured and updated in that period. For example, when the compensation revision cycle is set as one week, Nᵢⱼ[k] is measured five times from Monday to Friday and Mᵢⱼ[k], Lᵢⱼ[k] are updated five times. Then, it is combined with the statistical estimation method by using these pieces of data.

As the statistical estimation method, various methods can be arbitrarily employed. Most simply, the arithmetic mean is considered to be used. Moreover, information of dispersion, a confidence interval and the like can be used as a judgment material regarding whether there is a significant difference when comparing the sizes of Lᵢⱼ[k]. At this time, for example, it is sufficient if revision, such as examination regarding whether Lᵢⱼ[k] can be regarded to be larger than Lₜₕ at an appropriate significant level (for example, a p value=0.05) in step S603, is performed.

Furthermore, in the aforementioned description, in step S607, Mᵢ₁[k−1] is evaluated with respect to all the user groups Gi and only the compensation of the user group Gp with the largest Mᵢ₁[k−1] is increased by ΔW. However, when it is difficult to increase compensation for only one user group in terms of fairness, ΔW may be distributed at an appropriate rate in step S607. In other words, compensation smaller than the compensation of the user group Gp with the largest Mᵢ₁[k−1] may be distributed to other user groups. As the distribution method, arbitrary methods can be employed and compensation may be distributed at a fixed rate decided in advance. In addition, for example, a method of weighting the value of Mᵢ₁[k] or Lᵢ₁[k] and distributing the compensation may be employed. Furthermore, other methods may also be employed.

Moreover, similarly to step S607, the distribution method in step S605 may be modified to a method other than the aforementioned distribution method. In the aforementioned description of step S605, ΔW is equally divided to all user groups belonging to G[k]. However, in addition to the equal division, for example, ΔW may be distributed by weighting using the value of Mᵢ₁ [k] or Lᵢ₁[k] and the like.

The above method is continued until a desired distribution is obtained or an upper limit of the amount of compensation which can be granted is reached, so that it is possible to efficiently control the user arrival time distribution with limited funds.

Next, the case in which the time slot is classified into three or more will be described. When the time slot is classified into three or more, the above is generalized in consideration of transition probability to arbitrary time slots Ai to Aj, and the similar process can be applied. However, in relation to the possibility of transition, since the number of time slots is increased twice, processing is complicated. In this regard, there is a method for simplifying the incentive design as follows and simplifying processing.

For example, it is assumed that the time slot is classified in four of A1 to A4. First, the time slot is classified into two large groups (an early group={A1, A2, A3} and a late group={A4}) of the latest time slot and the other time slots, and simplification of a transition from a certain time slot belonging to the late group to a certain time slot belonging to the early group is made. In the current example, since a time slot belonging to the late group is only A4, simplification of a transition from A4 to any one of A1, A2, and A3 is made.

In other words, incentive design is performed such that “points are granted by ΔW1 when coming earlier than the latest time slot”. Then, ΔW1 is increased according to the aforementioned method, the number of persons of the latest time slot is reduced that can be satisfied, and grouping is revised again when a transition to the time slot of the early group has been made. In detail, A3 of the early group after A4 is shifted from the early group to the late group, and the group is divided into the early group={A1,A2} and the late group={A3,A4}.

Then, addition compensation of ΔW2 is granted to a user who has attended in the new early group (={A1,A2}). In other words, a user belonging to the early group can obtain compensation of ΔW1+ΔW2. There is a method in which the similar process is performed for the early group {A1} to add compensation ΔW3, and a gradual compensation amount is sequentially increased for decision according to necessity. When this is separately performed for each user group as described above, a compensation amount is finally decided for each Zᵢⱼ.

Note that, the aforementioned compensation amount revision cycle can be controlled only in an increase direction. Therefore, such as a change in a steady state, a compensation amount having reached an optimal state once may not be always optimal at other times. In order to cope with the steady state which changes as described above, it is effective that the revision cycle is reset once at an appropriate cycle, and is started again from an initial state (or an initial state at the time of reset decided in advance).

Furthermore, a time limit is added to points as compensation of a user, a maximum compensation amount is not excessively increased, and the points are not available if they are not used in a constant period, so that it is possible to prompt steady early attendance of a user. If the time limit is not added to points, a user can collect many points for example. In this case, in a situation in which benefits are large as the number of compensation points as an application is large (for example, when the acquired number of lots in a lottery is not limited, and the like), a situation, in which a user who have collected points exclusively may enjoy profits, may occur.

The exclusion of this situation depends on an administration policy, but the situation is not preferable when considering that the purpose is not gambling but prompting of the realization of a load distribution such as off-peak attendance. It is preferable that many users steadily accumulate slight improvement from the standpoint of system stability, as compared with the case in which some users temporarily perform off-peak attendance in a focused manner. Therefore, for example, it is preferable that a compensation point use period of about one week or one month is decided or a compensation amount to be granted is prevented from being excessively increased.

Subsequently, detailed implementation examples of the aforementioned present exemplary embodiment will be described.

### Implementation Example 1

The present implementation example is an example in which the aforementioned exemplary embodiment is realized by cooperating with a system using a location information application, and a visiting time to a real shop selling articles is controlled.

As the location information application, an application is considered in which location information of a user is registered using a location information function of a smart phone, a cellular phone and the like, virtual compensation such as virtual money is obtained, and the virtual compensation is used in a game.

For example, the application is an application in which points can be obtained when the sum of movement distances of a user has exceed a predetermined value or when a user has visited a strange place, various online games can be played using the points, or online shopping or prize can be obtained. Such an application, for example, cooperates with an actually existing shop and the like, and grants compensation capable of purchasing goods in a virtual shop in a virtual world when a user having visited the shop (a user having performed location registration at the place) purchases goods in that shop. In this way, a user is prompted to go to the shop.

The aforementioned exemplary embodiment is introduced to a platform of such an application, so that it is possible to realize the off-peak attendance or to more strongly prompt to a user to go a certain shop.

In the present implementation example, a method for controlling the number of visitors visiting to a certain shop will be described.

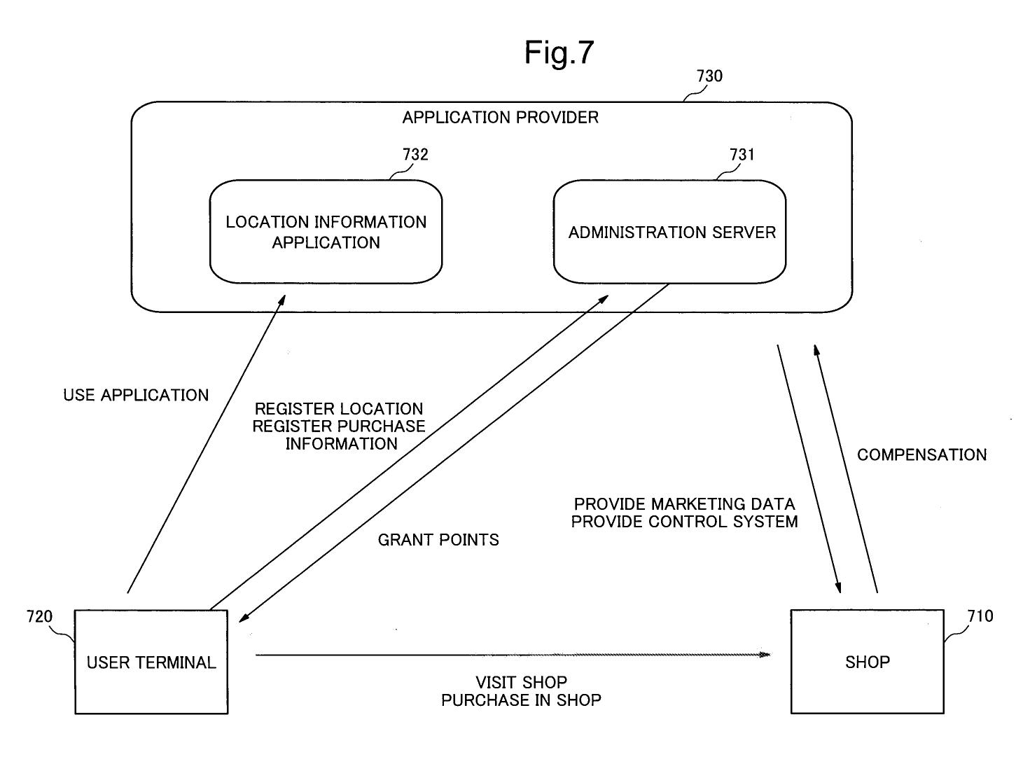

Referring to FIG. 7, the present implementation example includes a shop 710, a user terminal 720 carried by a user, and an application provider 730. Moreover, the application provider 730 includes a location information application 732 and an administration server 731. The shop 710 is for realizing the service spot 160, the user terminal 720 corresponds to the user terminal 110, and the location information application 732 and the administration server 731 are for realizing the administration server 130. In the current description, a system is realized through the application provider 730 in which a user belonging to a specific segment is prompted to visit a shop in a specific time zone.

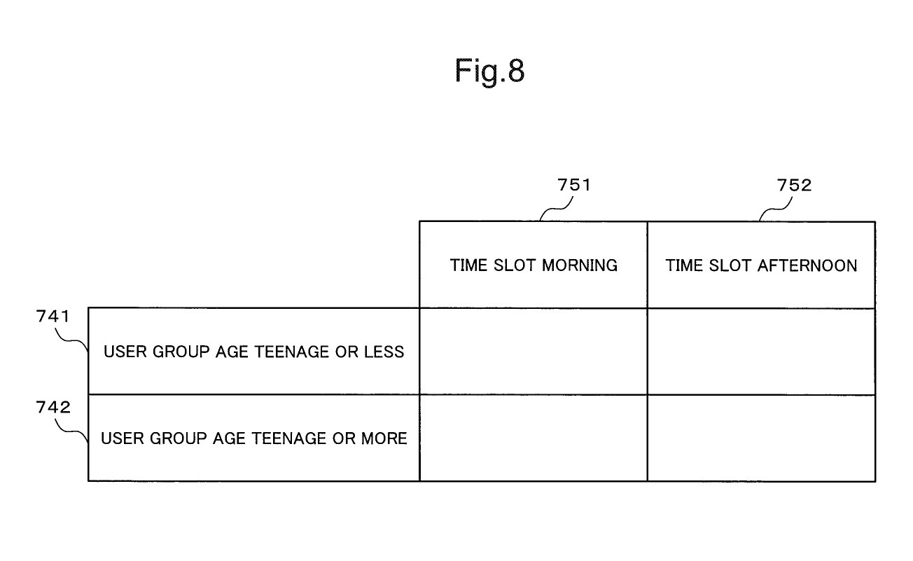

Furthermore, FIG. 8 illustrates time slots and user groups in the present implementation example as in the matrix illustrated in FIG. 3.

It is assumed that each user of a plurality of users is classified into any one of two segments of user segments 741 and 742 by attributes thereof. For the segments, the user segments 741 and 742 are classified in two corresponding to under 20 years old and 20 years old or above on the basis of the ages of respective users; however, this is merely one example. In general, a segmentation method is arbitrary, and users are assumed to be classified by segmentation advantageous in marketing.

Furthermore, among business hours of the shop 710, a visiting time is segmented into time slots 751 and 752. Also in this example, only two time slots corresponding to morning and afternoon are considered; however, in general, segmentation is possible with an arbitrary number of arbitrary classification.

As a consequence, in the present implementation example, four (2×2) user groups exist. In the shop 710, since the current number of teenage customers visiting in the afternoon is small, it is necessary to increase the number of the teenage customers visiting in the afternoon while focusing on the teenage customers.

In order to achieve such an object, the application provider 730 and the shop 710 forms a cooperative relation. Then, the application provider 730 administrates action information such as visitation to the shop of a user using the location information application 732, or purchase of goods in the shop. Furthermore, the application provider 730 controls compensation to be granted in response to such an action, and receives compensation from the shop 710 instead of controlling a visiting number distribution or providing the shop 710 with the result (marketing data).

Furthermore, the application provider 730 obtains desired visiting customer number distribution information (information related to a control method of a customer layer and a visiting time zone of the customer layer) from the shop 710. As described above, since it is necessary to increase the number of the teenage customers visiting in the afternoon while focusing on the teenage customers, users belonging to the time slot 751 and the user group 741 are controlled to move to the time slot 752 and the user group 741.

Furthermore, the application provider 730 performs incentive design on the basis of the user action information and the desired visiting customer number distribution information, and by using the incentive calculation method of the aforementioned exemplary embodiment. The application provider 730 displays, to each user segment, information related to the number of special points to be granted for visiting to a shop at a specific time or the number of special points to be granted for purchase of certain goods.

When a user carrying the user terminal 720 has visited a shop, the user registers the visiting time and location information in the administration server 731 by using a dedicated application installed in a smart phone corresponding to the user terminal 720 (corresponding to the user terminal 110), notifies the time at which the user has visited the shop or notifies information of purchased goods, thereby receiving compensation points. An action of the user is changed according to the number of compensation points. The notification of the purchase good information by the user, for example, can be realized by a method and the like in which the shop notifies the application provider 730 of some kind of a serial number together with action information, which represents that the goods have been purchased in the shop, when the goods have been purchased, and uploads the serial information.

The user carrying the user terminal 720 can use the compensation points obtained in response to his/her action in the location information application 732.

The application is a game and the like and a use method of the compensation points may be an arbitrary method. For example, the application may be an application capable of acquiring appropriate items, or may be such a lottery, for example, may be a gift of a constant rate to be granted to a user based on funds obtained from the shop 710. In other words, it is sufficient if the use method of the compensation points is a method in which many expected profits are obtained as the acquired compensation points is large.

Such user action information is provided to the shop 710 as a control result of user actions based on the incentive design, or marketing data.

The shop 710 can dynamically change the desired visiting customer number distribution information by use situations of the user changed in response to the incentive design. Furthermore, the application provider 730 further changes the incentive design on the basis of the changed desired visiting customer number distribution information, thereby continuing to control user actions.

By continuously performing such control, incentive is granted to a user having specific attributes visits the shop 710, other than other shops, in a specific time zone or purchases specific goods. Even when a response of the user for granted compensation is not known, it is possible to appropriately control cost for the compensation (the total amount of compensation granted to a user) and to induce a shift to a desired state of the shop 710.

### Implementation Example 2

In order to reduce transportation cost, a company providing a traffic service such as an electric railway company, an airline company, and a bus company preferably prompts off-peak attendance to the maximum extent, and avoids excessive congestion. In this regard, in the present implementation example, a system, in which the electric railway company, a company serving as an attendance destination, and the load control system based on the incentive design of the aforementioned exemplary embodiment cooperate with one another, thereby encouraging off-peak attendance of employees, will be described as an example.

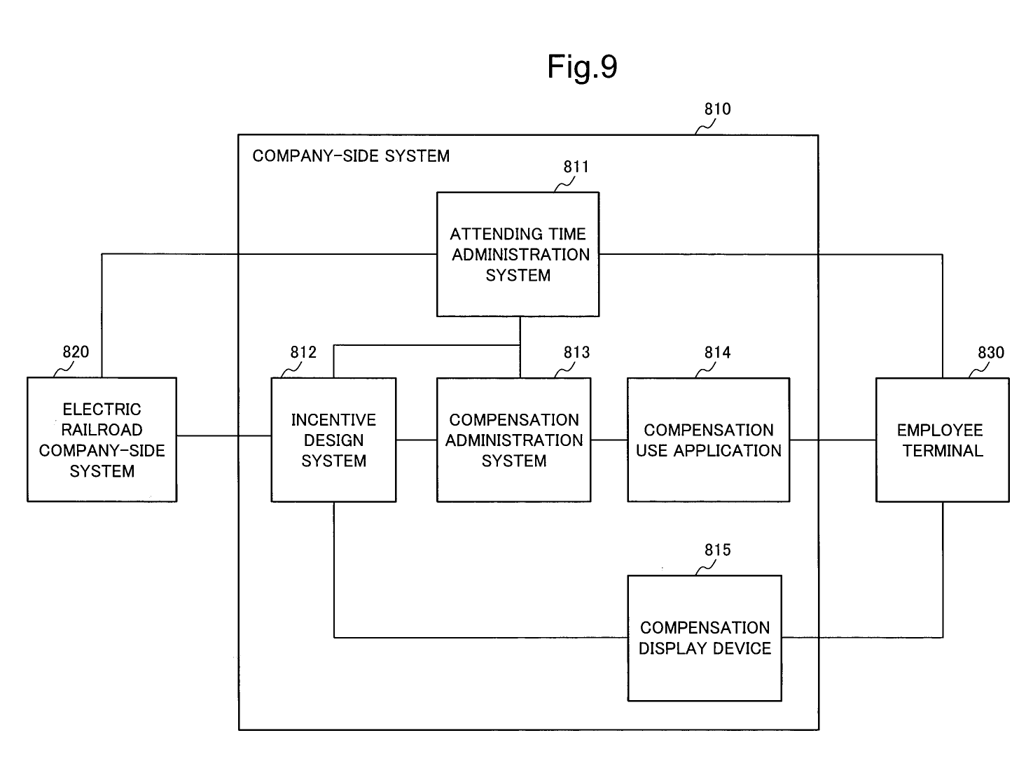

FIG. 9 is a block diagram illustrating a basic configuration in a second implementation example of an exemplary embodiment of the present invention. In the present implementation example, it is assumed that a company-side system 810, an electric railway company-side system 820, and an employee terminal 830 are exist, and an employee carrying the employee terminal 830 goes to company by using the electric railway company-side system 820.

An electric railway serving as the electric railway company-side system 820 is for realizing the service spot 160, the employee terminal 830 is for realizing the user terminal 110, and the company-side system 810 is for realizing the application provider 130.

Note that, in general, each employee carrying the employee terminal 830 uses one or a plurality of electric railway companies, or a used electric railway company differs in each employee. Therefore, it is necessary to classify employees for each of electric railway companies used by entire employees. However, in the current description, for the simplification of the description, it is assumed that only one of electric railway companies is considered and all the employees go to office by using the electric railway company.

An electric railway company having the electric railway company-side system 820 intends to smooth use times of employees having the employee terminal 830 as passengers to the maximum extent. As it approaches a business hour, arrival times of employees to an office of the company increase, and the electric railway company intends to prompt the employees to early go to office to the maximum extent.

The company-side system 810 includes an attending time administration system 811, an incentive design system 812, a compensation administration system 813, a compensation display device 815, and a compensation use application 814.

The attending time administration system 811 administrates attending times of employees carrying the employee terminal 830. The incentive design system 812 calculates and designs compensation points to employees. The compensation administration system 813 administrates compensation granted to employees. The compensation display device 815 is a display device for referring to compensation information. The compensation use application 814 is an application in which employees use compensation.

The electric railway company-side system 820 cooperates with the company-side system 810 and provides the company-side system 810 with service charge for realizing off-peak attendance of the employees carrying the employee terminal 830. The company-side system 810 grants compensation to employees contributed to the off-peak attendance. Furthermore, the company-side system 810 notifies the electric railway company-side system 820 of information representing an effect (the degree of realization of the off-peak attendance and the amount of compensation, or prediction thereof) as a result of granting the compensation. Based on the information, the electric railway company-side system 820 causes an increase and the like in service charge for increasing compensation.

The company-side system 810 may grant compensation points to the employee terminal 830 by the attending times of employees, and the employees carrying the employee terminal 830 can use the compensation use application 814, which uses the compensation points, by using the employee terminal 814. The compensation use application may have any content. For example, the content may be the grant of the monetary value such as a special bonus of a constant rate for an employee such as a lot, or the grant of a right for giving an advantage in using facilities in a company. In other words, it is sufficient if as company points are large, the possibility of obtaining profits becomes high.

Furthermore, employees can confirm the current number of company points by using the employee terminal 830 through the compensation display device 815. The compensation display device 815, for example, is realized by a Web system and the like in a company. The number of company points confirmable by the compensation display device 815 includes minimum information representing the degree of compensation according to an attending time. However, the content confirmable by the compensation display device 815 is not limited thereto. For example, in addition to this, information of details and the like of an attending time distribution of all employees may be displayed according to necessity. Furthermore, for example, in order to enhance preference, it may be possible to use an application and the like in which the number (a detailed number is not clear) of compensation points to be granted is made large in a time slot in which the number of attendants is small, and employees predict attending times from an attending time distribution of the last one week and make a strategy. In this case, it is also considered that the employees can independently and actively change an attending time, and more efficient incentive design can be performed.

Employees see current compensation information by the carried employee terminal 830, confirm or predict compensation points to be granted according to his/her attending times, and plan attending times of the next date. Furthermore, actual attending times of employees are administrated by the attending time administration system 811 that administrates the attending times of the employees by time cards and the like.

The incentive design system 812 decides the number of compensation points to be granted to each time slot and each user group, which have been classified by time slots and user groups set in advance by an administrator, by the aforementioned incentive design scheme based on information of user groups including each employee classified by a rule (for example, an attending time) decided in advance and actual attending time. The decided compensation amount information is disclosed to the employee 830 by the compensation display device 815. Furthermore, the compensation administration system 813 grants compensation points in response to attending times of users and administrates occupation point information of each employee. The employees can use acquired points in the compensation use application 814 by using the employee terminal 830 on the basis of the occupation point information administrated by the compensation administration system 813.

Furthermore, the compensation points may not have the available period in particular. However, it is preferable that the available period is limited such as available only in a certain constant period. The reason is for preventing the value of gain to be obtained from being excessively high when the accumulated number of acquired compensation points becomes excessively large, and resetting it at an appropriate interval, thereby prompting steady off-peak attendance of employees. For example, it is assumed that an application is a lottery and the number of times by which a lot is drawn is decided by compensation points. In this case, since a user may carry out an action of, before using a lottery after a little while, collecting many compensation points and buying up lots, it is not generally preferable because gambling property is too strong. Furthermore, since the original purpose is to prompt steady off-peak attendance and early attendance, when compensation points are accumulated indefinitely, it is probable that it is contrary to the purpose. Therefore, it is preferable that reset of compensation points is repeated in a period which is not too long.

The company-side system 810 notifies the electric railway company-side system 820 of a change in the attending time distribution as a result of such processes. Based on the information, the electric railway company-side system 820 can recognize the degree of an effect to the off-peak of the provided service charge. Moreover, it is also possible to provide information representing the degree of an expected off-peak effect according to an increase amount.

Note that, in order to administrate the attending time, the attending time administration system 811 may be used as described above. However, instead, an actual boarding time may be administrated using a ticket or a season ticket provided with an IC chip such as Suica (registered trademark) or PASMO (registered trademark), and corresponding information may be shared with the incentive design system 812. For example, the time point at which an employee has passed through a ticket gate of a station nearest to the company 810 using Suica may also be regarded as attendance.

Furthermore, in the aforementioned description, an arrival time of a user is particularly focused. However, the use purpose of the present exemplary embodiment is not limited thereto, and may be applied to arbitrary purposes. For example, the use purpose can be understood as purposes of smoothing and the like of a use time zone of use resources of computer and the like.

For example, it is considered that the present exemplary embodiment is applied to an online game realized using a certain server device.

In such a server device, it is considered that there is a difference in time zones accessed by users. For example, it is also considered that access is concentrated in a certain time zone and access is not concentrated in other time zones. In such a case, compensation points are adjusted such that user access the server device in the other times other than the time zone in which access is concentrated. In this way, a congestion rate is smoothed in the server device. Note that, in this case, it is also considered that compensation is made available on the online game.

The exemplary embodiment of the present invention as described above obtains many advantageous effects below.

A first advantageous effect obtained by the exemplary embodiment of the present invention is that it is possible to efficiently control a load of a general system with low cost such as the reduction of a congestion rate and control of a visitation distribution to a specific place.

The reason is because the use load of a system is controlled in cooperation with a location information application using a portable terminal extensively spread in recent years and capable of acquiring location information. Moreover, the reason is because the exemplary embodiment of the present invention provides a scheme of efficiently controlling the amount of compensation to be granted for encouraging a user action, which has an influence on the use load state of the system, to be contributed to realizing a target state in consideration of a user effect for the grant of compensation available in the application.

A second advantageous effect obtained by the exemplary embodiment of the present invention is that it is possible to realize the target use state of the system with cost (the amount of compensation to be granted) as low as possible.

The reason is because the exemplary embodiment of the present invention provides an incentive design method capable of efficiently motivating users to carry out a specific action even when details of responses of users for compensation are unknown in consideration of the fact that the responses of users for compensation differ according to the attributes of the users.

Note that, each of the aforementioned administration server and user terminal and the arrival time distribution control system including the same are configured by hardware such as an integrated circuit. However, it can be realized by software or a combination of software and hardware. Furthermore, the incentive design method performed by the aforementioned administration server and user terminal and the arrival time distribution control system including the same can also be realized by hardware, software, or a combination thereof. The realization by software means that a computer read and executes a program, so that the incentive design method is performed.

The program can be stored using various types of non-transitory computer readable mediums, and can be supplied to a computer. The non-transitory computer readable medium includes various types of tangible storage mediums. An example of the non-transitory computer readable medium includes a magnetic recording medium (for example, a flexible disk, a magnetic tape, a hard disk drive), a magneto-optical recording medium (for example, a magneto-optical disk), a CD-ROM (Read Only Memory), a CD-R, a CD-R/W, a semiconductor memory (for example, a mask ROM, a PROM (Programmable ROM), an EEPROM (Erasable ROM), a flash ROM, a RAM (random access memory). Furthermore, the program may also be supplied to the computer by various types of transitory computer readable mediums. An example of the transitory computer readable medium includes an electrical signal, an optical signal, and an electromagnetic wave. The transitory computer readable medium can supply the program to the computer via a wired communication path such as an electric wire and an optical fiber or a wireless communication path.

In the above, the representative exemplary embodiment of the present invention has been described. However, the present invention can be implemented in various forms without departing from the spirit or main features thereof defined by the appended claims of the present application. Therefore, the aforementioned each exemplary embodiment is only a simple example, and it should be noted that it is not construed in a manner limited by the example. The scope of the present invention is defined by the scope of the appended claims, and is not limited to the description of the specification or the abstract. Moreover, all modifications and changes belonging to equivalents of the claims are considered to fall within the scope of the present invention.

This application is based upon and claims the benefit of priority from Japanese Patent Application No. 2012-219547 filed on Oct. 1, 2012, the entire contents of which are incorporated herein by reference. The content of Japanese Patent Application No. 2012-219547 is included in the content of the present specification.

Some or all of the exemplary embodiments are described as the following Supplementary Notes, but are not limited to the following.

Some or all of the exemplary embodiments are described as the following Supplementary Notes, but are not limited to the following.

(Supplementary Note 1) An arrival time distribution control device in an environment in which a plurality of users arrive at a predetermined base at arbitrary times on the basis of compensation which is granted corresponding to respective judgment references and arrival times, wherein

the arrival time distribution control device repeats calculation of an arrival time distribution based on the arrival times of the plurality of users having arrived at the predetermined base, and changes a content of the compensation which is granted to the users who arrive at the predetermined base next time so as to reach a target arrival time distribution, on the basis of either a first difference between a currently calculated arrival time distribution and a previously calculated arrival time distribution, or a third difference between the first difference and a second difference between the previously calculated arrival time distribution and an arrival time distribution calculated prior to the previously calculated arrival time distribution whenever the calculation is performed.

(Supplementary Note 2) The arrival time distribution control device according to Supplementary Note 1, wherein the arrival time distribution control device includes:

a registration unit that registers the arrived base and the arrival times when the plurality of users have arrived at the predetermined base;

an incentive design unit that obtains the first or the third difference on the basis of a registration content of the registration unit, and decides an object to which compensation is granted next time and an amount of the compensation to be granted next time on the basis of the first or the third difference and an object to which compensation is granted and an amount of the compensation, which have been previously presented;

a presentation unit that presents the decided object to which the compensation is granted next time and the amount of the compensation to be granted next time to the users; and

an application implementation means that provides convenience to the users by allowing the granted compensation to be used.

(Supplementary Note 3) The arrival time distribution control device according to Supplementary Note 2, wherein

the users are classified into a plurality of first segments classified by employing a difference of responses for a compensation amount as a reference, and are registered in the registration unit, and

the incentive design unit decides whether to grant the compensation and an amount of the compensation to be granted in a case of granting the compensation, for each arrival time of the users and each first segment to which the users belong.

(Supplementary Note 4) The arrival time distribution control device according to Supplementary Note 2, wherein

the users are classified into a plurality of second segments by dividing the arrival times to the base into time slots with lengths of predetermined time zones, and are registered in the registration unit, and

the incentive design unit increases compensation which is granted to users belonging to the second segments decided so as to reach the target arrival time distribution.

(Supplementary Note 5) The arrival time distribution control device according to Supplementary Note 3 or 4, wherein

the first difference is an increase amount of a number of users belonging to each segment, which has been changed as a result of granting the compensation, the third difference is a change amount of the increase amount, and the incentive design unit decides whether to grant compensation next time and an amount of the compensation to be granted next time for each segment on the basis of the first difference or the third difference.

(Supplementary Note 6) The arrival time distribution control device according to Supplementary Note 5, wherein,

when there are segments in which the change amount of the increase amount of the number of the users belonging to each segment is equal to or more than a threshold value, the incentive design unit assigns a compensation increase amount only to all segments, in which the change amount is equal to or more than the threshold value, at a rate multiplied by a predetermined weight, and

when there are no segments in which the change amount of the increase amount of the number of the users belonging to each segment is equal to or more than the threshold value, the incentive design unit evaluates the increase amount of the number of the users with respect to all the segments and assigns the compensation increase amount to a user segment with largest increase amount of the number of the users at a rate decided in advance.

(Supplementary Note 7) The arrival time distribution control device according to any one of Supplementary Notes 1 to 6, wherein

the amount of the compensation to be granted is sequentially increased from a predetermined initial value whenever the amount of the compensation is changed, and when a distribution of base arrival times of the users becomes a distribution of the desired base arrival times set in advance as a result of the increase, the amount of the compensation is not increased.

(Supplementary Note 8) The arrival time distribution control device according to any one of Supplementary Notes 1 to 7, wherein

the compensation has a limited available period.

(Supplementary Note 9) An arrival time distribution control system including:

a portable terminal having a positioning function; and

the arrival time distribution control device according to any one of claims 2 to 8,

wherein the users carry the portable terminal, and the registration is performed for the registration unit on the basis of location information measured by the portable terminal.

(Supplementary Note 10) An arrival time distribution control method which is performed by an arrival time distribution control device in an environment in which a plurality of users arrive at a predetermined base at arbitrary times on the basis of compensation which is granted corresponding to respective judgment references and arrival times, wherein

repeating calculation of an arrival time distribution, which is a time distribution of users having arrived at the predetermined base, and changing a content of the compensation whenever the calculation is performed, which is granted to the users who arrive at the predetermined base next time, so as to reach a target arrival time distribution, on the basis of either a first difference between a currently calculated arrival time distribution and an previously calculated arrival time distribution, or a third difference between the first difference and a second difference between the previously calculated arrival time distribution and an arrival time distribution calculated prior to the previously calculated arrival time distribution.

(Supplementary Note 11) An arrival time distribution control program that causes a computer to serve as an arrival time distribution control device in an environment in which a plurality of users arrive at a predetermined base at arbitrary times on the basis of compensation which is granted corresponding to respective judgment references and arrival times, wherein

the arrival time distribution control program causes the computer to perform:

a function of repeating calculation of an arrival time distribution, which is a time distribution of users having arrived at the predetermined base, and obtaining a first difference between a currently calculated arrival time distribution and an immediately previous calculated arrival time distribution, or a third difference between the first difference and a second difference between the previously calculated arrival time distribution and an arrival time distribution calculated prior to the immediately previous calculated arrival time distribution whenever the calculation is performed, and

a function of changing a content of the compensation which is granted to the users who arrive at the predetermined base next time so as to reach a target arrival time distribution.

(Supplementary Note 12) An incentive design method and a control system of a system load, which includes a plurality of users and controls a load amount or a resource consumption amount occurring in a base or on their way when the users move to the base in an arbitrarily decided place in order to receive an arbitrary service according to respective judgment references, in cooperation with a location information administration system, wherein

the incentive design method and the control system of a system load repeats a series of processes to allow a base arrival distribution of the users to gradually approach an arrival time distribution registered in advance, and

the series of processes are processes in which the users use an application provided from the location information administration system or an operator of the service spot,

the users have a terminal capable of acquiring a current position and time information and registering the position and the time information in the location information administration system through communication via a network, and register a position and time information by using the terminal when the users have arrived at the base,

the location information administration system administrates base arrival time information of the users, grants compensation to the users on the basis of the base arrival time information of the users, performs incentive design for deciding compensation to be granted next time, and discloses, to the users, the plan and compensation information of the amount of compensation to be granted, and

the users browse the compensation information to draft and perform the next movement time plan, acquire compensation from the result, and consume acquired as benefits in the use of the application.

(Supplementary Note 13) The incentive design method and the control system of a system load in which the users according to Supplementary Note 12 are classified into a plurality of user segments based on characteristics of responses to the compensation, and the amount of compensation to be granted differ in each arrival time and segment including the users.

(Supplementary Note 14) The incentive design method and the control system of a system load in which the incentive design method according to Supplementary Note 12 is a scheme of starting a compensation grant plan from an appropriate initial value, realizing the target arrival time distribution by using an arrival time history of users, or sequentially increasing a compensation amount until the total amount of granted compensation reaches an upper limit of compensation,

an arrival time is segmented into a plurality of time slots, and the next compensation amount is decided using a change amount of the number of users having arrived at each time slot with respect to a change in the set compensation, and a change amount of the change amount,

preferably, a compensation amount differing in each user segment based on response characteristics to the compensation of the users of Supplementary Note 12 is set, and more preferably, a compensation increase amount is assigned to, at a rate with an appropriate weight, all user segments in which the change amount of the change amount of the number of users having arrived at each time slot and belonging to different user segments is equal to or more than a threshold value, and when a change amount of a change amount of the number of users of all the user segments having arrived at each time slot is smaller than the threshold value, the compensation increase amount is assigned to all the user segments at a rate decided in advance.

(Supplementary Note 15) The incentive design method and the control system of a system load, in which the location information device according to Supplementary Note 12 is a portable terminal that acquires location information through location estimation using base station information.

(Supplementary Note 16) The incentive design method and the control system of a system load, in which the compensation according to Supplementary Note 12 has a limited available period.

(Supplementary Note 17) The incentive design method and the control system of a system load, in which the application according to Supplementary Note 12 is a game with high entertainment characteristics or an application having gambling properties such as a lottery, and the acquired compensation according to Supplementary Note 11 and Supplementary Note 15 is compensation that always gives direct monetary profits to users, and is preferably compensation that provides indirect benefits, which provides benefits at the time of acquisition of virtual articles on a game or provides benefits at the time of acquisition of a gift in a lottery.

(Supplementary Note 18) The incentive design method and the control system of a system load in which the location information administration system according to Supplementary Note 12 and an operator of the service spot form a cooperative relation for entrusting administration of a compensation amount to be granted for improving use benefits on an application used by users to the location information administration system having a location information administration function of users for the purpose of controlling the amount of resources consumed by users in the service spot,

the operator of the service spot presents the target arrival time distribution obtained as a result of the incentive design and upper limit information of a compensation amount to be granted, the location information administration system administrates arrival time information of users on the basis of the presented information, provides the operator of the service spot with temporal transition information of the arrival times of users and history information of the compensation amount to be granted or prediction information on the basis of the information, and more preferably, the operator of the service spot dynamically changes the target arrival time distribution and the upper limit information of the compensation amount to be granted on the basis of the history information or the prediction information.

### INDUSTRIAL APPLICABILITY

The present invention can be applied to incentive design for an arbitrary object in an arbitrary system without particularly limiting an application range thereof. Furthermore, the present invention can be applied to incentive design of an arbitrary purpose without particularly limiting the purposes of incentive design.

### REFERENCE SIGNS LIST

101 User
110 User terminal
111 Location measurement unit
112 Location registration unit
113 Communication unit
120 Network
130 Administration server
131 Communication unit
132 Data administration unit
133 Information display unit
134 Incentive design unit
135 Service provision application
150 System to be controlled
160 Service spot
710 Shop
720 User terminal
730 Application provider
731 Administration server
732 Location information application
810 Company-side system
811 Attending time administration system
812 Incentive design system
813 Compensation administration system
814 Compensation use application
815 Compensation display device
820 Electric railway company-side system
830 Employee terminal

1. An arrival time distribution control device in an environment in which a plurality of users arrive at a predetermined base at arbitrary times on the basis of compensation which is granted corresponding to respective judgment references and arrival times, wherein
the arrival time distribution control device repeats calculation of an arrival time distribution based on the arrival times of the plurality of users having arrived at the predetermined base, and changes a content of the compensation which is granted to the users who arrive at the predetermined base next time so as to reach a target arrival time distribution, on the basis of either a first difference between a currently calculated arrival time distribution and a previously calculated arrival time distribution, or a third difference between the first difference and a second difference between the previously calculated arrival time distribution and an arrival time distribution calculated prior to the previously calculated arrival time distribution whenever the calculation is performed.

2. The arrival time distribution control device according to claim 1, wherein the arrival time distribution control device comprises:
a registration unit that registers the arrived base and the arrival times when the plurality of users have arrived at the predetermined base;
an incentive design unit that obtains the first or the third difference on the basis of a registration content of the registration unit, and decides an object to which compensation is granted next time and an amount of the compensation to be granted next time on the basis of the first or the third difference and an object to which compensation is granted and an amount of the compensation, which have been previously presented;
a presentation unit that presents the decided object to which the compensation is granted next time and the amount of the compensation to be granted next time to the users; and
an application implementation unit that provides convenience to the users by allowing the granted compensation to be used.

3. The arrival time distribution control device according to claim 2, wherein
the users are classified into a plurality of first segments classified by employing a difference of responses for a compensation amount as a reference, and are registered in the registration unit, and
the incentive design unit decides whether to grant the compensation and an amount of the compensation to be granted in a case of granting the compensation, for each arrival time of the users and each first segment to which the users belong.

4. The arrival time distribution control device according to claim 2, wherein
the users are classified into a plurality of second segments by dividing the arrival times to the base into time slots with lengths of predetermined time zones, and are registered in the registration unit, and
the incentive design unit increases compensation which is granted to users belonging to the second segments decided so as to reach the target arrival time distribution.

5. The arrival time distribution control device according to claim 3, wherein
the first difference is an increase amount of a number of users belonging to each segment, which has been changed as a result of granting the compensation, the third difference is a change amount of the increase amount, and the incentive design unit decides whether to grant compensation next time and an amount of the compensation to be granted next time for each segment on the basis of the first difference or the third difference.

6. The arrival time distribution control device according to claim 5, wherein,
when there are segments in which the change amount of the increase amount of the number of the users belonging to each segment is equal to or more than a threshold value, the incentive design unit assigns a compensation increase amount only to all segments, in which the change amount is equal to or more than the threshold value, at a rate multiplied by a predetermined weight, and
when there are no segments in which the change amount of the increase amount of the number of the users belonging to each segment is equal to or more than the threshold value, the incentive design unit evaluates the increase amount of the number of the users with respect to all the segments and assigns the compensation increase amount to a user segment with largest increase amount of the number of the users at a rate decided in advance.

7. The arrival time distribution control device according to claim 1, wherein
the amount of the compensation to be granted is sequentially increased from a predetermined initial value whenever the amount of the compensation is changed, and when a distribution of base arrival times of the users becomes a distribution of the desired base arrival times set in advance as a result of the increase, the amount of the compensation is not increased.

8. The arrival time distribution control device according claim 1, wherein
the compensation has a limited available period.

9. An arrival time distribution control system comprising:
a portable terminal having a positioning function; and
the arrival time distribution control device according to claim 2,
wherein the users carry the portable terminal, and the registration is performed for the registration unit on the basis of location information measured by the portable terminal.

10. An arrival time distribution control method which is performed by an arrival time distribution control device in an environment in which a plurality of users arrive at a predetermined base at arbitrary times on the basis of compensation which is granted corresponding to respective judgment references and arrival times, wherein
repeating a calculation of an arrival time distribution, which is a time distribution of users having arrived at the predetermined base, and changing a content of the compensation whenever the calculation is performed, which is granted to the users who arrive at the predetermined base next time, so as to reach a target arrival time distribution, on the basis of either a first difference between a currently calculated arrival time distribution and an previously calculated arrival time distribution, or a third difference between the first difference and a second difference between the previously calculated arrival time distribution and an arrival time distribution calculated prior to the previously calculated arrival time distribution.

11. The arrival time distribution control device according to claim 4, wherein
the first difference is an increase amount of a number of users belonging to each segment, which has been changed as a result of granting the compensation, the third difference is a change amount of the increase amount, and the incentive design unit decides whether to grant compensation next time and an amount of the compensation to be granted next time for each segment on the basis of the first difference or the third difference.

12. The arrival time distribution control device according to claim 2, wherein
the amount of the compensation to be granted is sequentially increased from a predetermined initial value whenever the amount of the compensation is changed, and when a distribution of base arrival times of the users becomes a distribution of the desired base arrival times set in advance as a result of the increase, the amount of the compensation is not increased.

13. The arrival time distribution control device according to claim 3, wherein
the amount of the compensation to be granted is sequentially increased from a predetermined initial value whenever the amount of the compensation is changed, and when a distribution of base arrival times of the users becomes a distribution of the desired base arrival times set in advance as a result of the increase, the amount of the compensation is not increased.

14. The arrival time distribution control device according to claim 4, wherein
the amount of the compensation to be granted is sequentially increased from a predetermined initial value whenever the amount of the compensation is changed, and when a distribution of base arrival times of the users becomes a distribution of the desired base arrival times set in advance as a result of the increase, the amount of the compensation is not increased.

15. The arrival time distribution control device according to claim 5, wherein
the amount of the compensation to be granted is sequentially increased from a predetermined initial value whenever the amount of the compensation is changed, and when a distribution of base arrival times of the users becomes a distribution of the desired base arrival times set in advance as a result of the increase, the amount of the compensation is not increased.

16. The arrival time distribution control device according to claim 6, wherein
the amount of the compensation to be granted is sequentially increased from a predetermined initial value whenever the amount of the compensation is changed, and when a distribution of base arrival times of the users becomes a distribution of the desired base arrival times set in advance as a result of the increase, the amount of the compensation is not increased.

17. The arrival time distribution control device according claim 2, wherein
the compensation has a limited available period.

18. The arrival time distribution control device according claim 3, wherein
the compensation has a limited available period.

19. The arrival time distribution control device according claim 4, wherein
the compensation has a limited available period.

20. The arrival time distribution control device according claim 5, wherein
the compensation has a limited available period.
